(19) United States
(12) Patent Application Publication
(10) Pub. No.: US 2015/0325112 A1
(43) Pub. Date: Nov. 12, 2015

(54) CEILING FAN CONTROL SYSTEM

(71) Applicant: Hunter Fan Company, Memphis, TN (US)

(72) Inventors: Matthew McPherson, Memphis, TN (US); Jeremy Tarr, Oakland, TN (US)

(21) Appl. No.: 14/705,277

(22) Filed: May 6, 2015

Related U.S. Application Data
(60) Provisional application No. 61/989,737, filed on May 7, 2014.

(51) Int. Cl. G08C 17/02; H04W 4/00; H04W 72/04

(52) U.S. Cl. CPC G08C 17/02; H04W 72/0453; H04W 4/008; G08C 2201/93

(57) ABSTRACT

A ceiling fan controller for controlling the operation of one or more ceiling fans using a wireless device includes a first radio transmitter/receiver operating at a first frequency suitable for communicating with the wireless device and a second radio transmitter/receiver operating at a second frequency suitable for communicating with the one or more ceiling fans and a processor operably coupled to the first and second radio transmitters to control the sending and receiving of data messages to and from the wireless device and the ceiling fan to control the operation of the ceiling fan via the wireless device.

### CROSS-REFERENCE TO RELATED APPLICATIONS

This application claims the benefit of U.S. Provisional Patent Application No. 61/989,737, filed May 7, 2014, which is incorporated herein by reference in its entirety.

### FIELD

The disclosure is related to a ceiling fan control system and method of controlling and manipulating the functional features, including the cooling and lighting functions, of one or more ceiling fans, wherein such fan control and manipulation is via a wireless device.

### BACKGROUND

Ceiling fans have been widely used to provide a cooling function as well as a lighting function to consumers. Controlling such cooling and lighting functions of existing ceiling fans is complex and cumbersome for the user, with such fans having limited incremental features. Ceiling fans offer cooling and lighting functional features which are usually operated by one or more pull chains and/or by a remote control. Such cooling feature typically includes several speeds: high, medium, low and off. The lighting feature of the fan typically includes the options: on/off/incremental dimming.

The cooling and lighting features are typically operated by pull chains. Existing ceiling fans comprise switch housings that contain the mechanical hardware which provide the operation to the functional features of the ceiling fan. Such mechanical hardware typically include pull chains switches, a reverse switch, capacitors, a limiter, wiring and connectors. The switch housing interfaces with a standard 9-pin connector which serves as a universal connection point to provide power to lights, accessories and the motor of the fan.

Operating and/or controlling the cooling and lighting features of a ceiling fan by pull chains has its disadvantages. A ceiling fan typically includes two pull chains, a first pull chain for controlling the fan speed and the second pull chain for controlling the lighting feature. Although the pull chains are often labeled to clarify which pull chains provides which function; these labels are not readily visible and consumers are often confused as to which pull chain provides the desired function. Moreover, consumers often get confused and frustrated when manipulating the pull chains to achieve the desired fan speed resulting in multiple consecutive unnecessary actuations of the pull chains. Additionally, because the ceiling fan is secured to the ceiling and suspended therefrom, the pull chains are often difficult for users to reach depending on the height of the user, the height of the ceiling fan suspension, or both. Another disadvantage to pull chains is that such pull chains may also be a distraction during the operation of the ceiling fan. For example, the two pull chains may sway during the operation of the fan which may lead the consumer to believe the ceiling fan is wobbling.

Ceiling fans also typically include a reverse switch which controls the rotary direction of the motor and thus the direction of the air flow. Controlling the direction of the air flow via a reverse switch is also difficult for the consumer due to the reverse switch being located on the switch housing of the suspended ceiling fan. Although a simple switch to operate, the reverse switch is difficult for the consumer to reach and therefore operate due to the elevated location of the ceiling fan.

Ceiling fans features, such as the cooling and lighting functions, may also be controlled by remote control operation. Such remote control operation includes using a remote controller to transmit wireless signals to the ceiling fan. Those signals are received by a receiving unit housed within the canopy of the ceiling fan to control the cooling and lighting operations of the ceiling fan. Operating and/or controlling the ceiling fan by an accessory remote control operation also has its disadvantages including the expense and difficulty associated with the installation of the required canopy mounted receiver. Additionally, any maintenance and service required is extremely difficult, making it only practical to install the remote control feature at initial installation. Moreover, while accessory remote control operation may provide the cooling and lighting functional features, such remote control operation is unable to provide control of the reverse air flow feature, and thus a reverse switch, which requires manual operation, must still be used in addition to an accessory remote control operation.

Moreover, the existing methods used to control a ceiling fan are limiting due to the fact that only one fan may be controlled and manipulated by such methods at any one time. For example, when controlling a fan by pull chains, only one fan is connected to the pull chain switches and thus only one fan is capable of being controlled by the manipulation of such pull chains. Also, when controlling a fan by accessory remote control, only one remote control transmits signals to one corresponding unit located in such ceiling fan and, thus only one fan is capable of being controlled by the remote control.

A ceiling fan control system and method used to control and manipulate basic as well as enhanced functional features of a one or more ceiling fans independently of pull chains and reverse switches and in conjunction with existing remote control operation is needed. Moreover, a ceiling fan control system and method of use to control and manipulate basic as well as enhanced functional features of a plurality of ceiling fans located within a defined location, wherein such fan control and manipulation is via a wireless device, is needed.

### SUMMARY

In one aspect, an embodiment of the invention relates to a ceiling fan controller for controlling the operation of one or more ceiling fans using a wireless device having a first radio transmitter/receiver operating at a first frequency suitable for communicating with the wireless device; a second radio transmitter/receiver operating at a second frequency, different from the first frequency, suitable for communicating with the one or more ceiling fans; a processor operably coupled to the first and second radio transmitters to control the sending and receiving of data messages to and from the wireless device and the ceiling fan to control the operation of the ceiling fan via the wireless device; and a power supply configured to receive power from a power source independent of the wireless device and the fan controller and supplying the received power in a form usable by the first and second radio transmitters.

In another aspect, an embodiment of the invention relates to a ceiling fan system for use in controlling ceiling fans by a wireless device communicating at a first radio frequency. The ceiling fan system includes multiple ceiling fans having a radio frequency receiving unit operating at a second frequency, different than the first frequency and a ceiling fan controller. The ceiling fan controller comprises a first radio transmitter/receiver operating at the first frequency to communicate with the wireless device; a second radio transmitter/receiver operating at a second frequency to communicate with the multiple ceiling fans; and a processor operably coupled to the first and second radio transmitters to control the sending and receiving of data messages to and from the wireless device and the ceiling fan to control the operation of the ceiling fans via the wireless device.

### BRIEF DESCRIPTION OF THE DRAWINGS

FIG. 1A is a schematic diagram of a ceiling fan control system comprising a fan controller and a wireless control device, such as a smart phone, of a preferred form of the invention.

FIG. 1B is a schematic diagram of an embodiment of a ceiling fan control system comprising a fan controller and a wireless control device, illustrating a simplified block diagram of the components of the fan controller.

FIG. 2A is a series of screenshots illustrating the function of the wireless control device for controlling the communication data transmitted to the fan controller of the ceiling fan control system of FIG. 1.

FIG. 2B is a series of screenshots illustrating the function of the wireless control device for controlling the communication data transmitted to the fan controller of the ceiling fan control system of FIG. 1.

FIG. 3 is a simplified block diagram of the communication and data flow process of the ceiling fan control system of FIG. 1.

FIG. 4 is a simplified block diagram of the components of a fan controller including an offline power circuit of FIG. 1.

FIG. 5 is a simplified block diagram of the components of a fan controller including an inline power stealing circuit according to another preferred form of the invention.

FIG. 6 is a schematic wiring diagram of a control circuit including an offline power circuit.

FIG. 7 is a schematic wiring diagram of a second illustrative control circuit including a switch and an inline power stealing circuit.

FIG. 8 is a simplified flow diagram depicting an example embodiment for programming or controlling the fan controller via the wireless control device.

FIG. 9 is an exploded view of the hardware components of the fan controller of FIG. 1.

FIG. 10 is an exploded view of the hardware components of an embodiment of the fan controller to be mounted to a wall.

### DETAILED DESCRIPTION

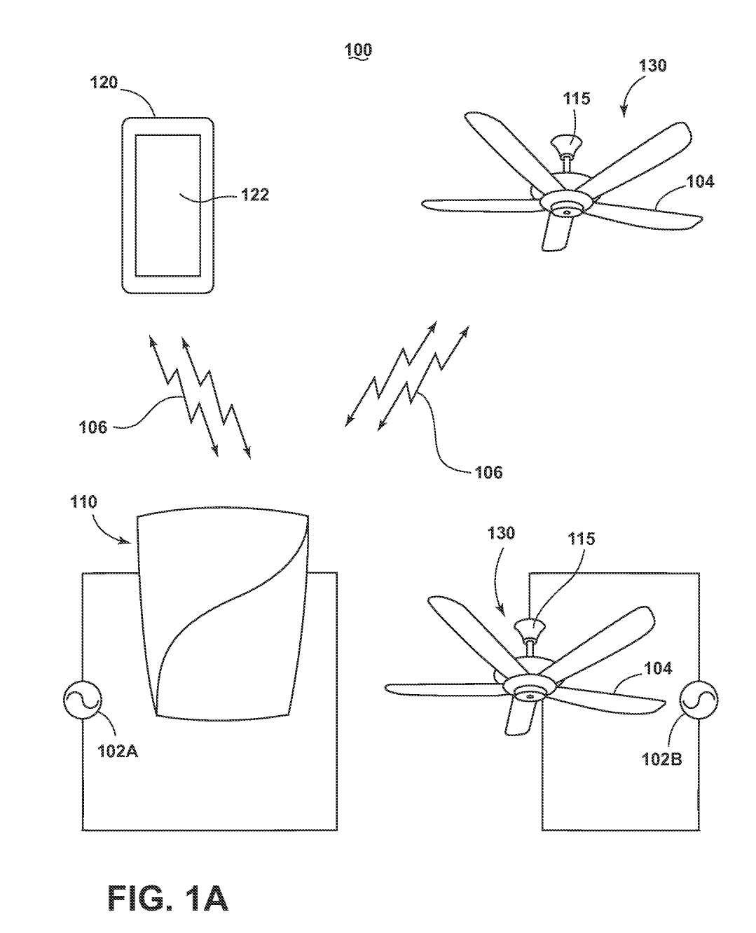

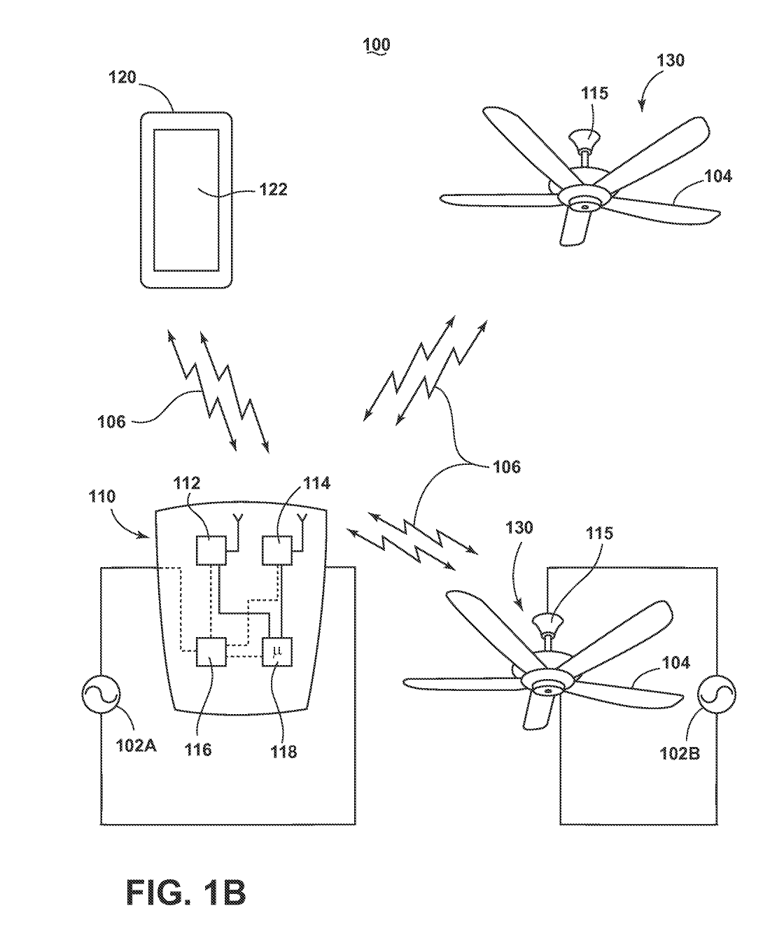

With reference next to the drawings, there is shown a ceiling fan control system and method of use for controlling and manipulating functional features of a one or more ceiling fans in a preferred form of the invention. Referring to FIGS. 1A and 1B, a radio frequency ceiling fan control system 100 is disclosed having a fan controller 110, a wireless control device 120, and at least one ceiling fan 130 having a receiving unit 115. The wireless control device (or wireless device) 120 can be any portable electronic device including, but not limited to, a smartphone, a personal digital assistant (PDA), a laptop, personal computer (PC), a portable media player such as an MP3 player, a gaming device, a television, a tablet device or any other Internet Protocol-enabled device.

The fan controller 110 includes a first radio transmitter/receiver 112, a second radio transmitter/receiver 114, a processor 118 operably coupled to the first and second radio transmitters and a power supply 116. The first radio transmitter/receiver 112 operates to enable communications between the wireless control device 120 and the fan controller 110. The second radio transmitter/receiver 114 operates to enable communications between the fan controller 110 and the receiving unit 115 of at least one ceiling fan 130. The processor 118 controls the sending and receiving of data messages to and from the wireless control device 120 and the one or more ceiling fans 130.

The power supply 116 is configured to receive electrical power (shown in dotted lines) from a power source. The power source can be any electrical power source capable of delivering alternating current (AC) or direct current (DC) power, including but not limited to mains power 102 common to household wiring for consumer electrical power distribution system. In one embodiment as shown in FIG. 1A, the fan controller 110 receives electrical power from a common circuit of mains power 102 that powers one or more ceiling fans 130. In another embodiment, as shown in FIG. 1B, the fan controller 110 receives electrical power from a circuit of mains power 102A separate from a circuit of mains power 102B that powers one or more ceiling fans 130. Than fan controller 110 via the power supply 116 receives the electrical power and supplies the electrical to the first and second radio transmitters 112, 114 and the processor 118. The power supply 116 can include electrical components to convert the electrical characteristics of the power source to the electrical characteristics required of the first and second radio transmitters 112, 114 and the processor 118. For example, the power supply 116 can covert from AC to DC power.

The wireless control device 120 may be operable to communicate data messages via wireless signals such as radio frequency signals 106 to one or more fan controllers 110 via a direct wireless communication link such as a Bluetooth communication technology owned by Bluetooth Sig, Inc. The wireless control device 120 may be operable to establish a wireless communication link with a plurality of fan controllers 110. The Bluetooth specification defines a uniform structure for a wide range of devices to connect and communicate with each other. The wireless control device 120 communicates data messages to and from fan controller 110 via Bluetooth Smart Technology. Bluetooth Smart Technology includes Bluetooth low energy protocols. Bluetooth low energy (BLE) is a subset of Bluetooth v4.0 and includes a protocol stack for rapid build-up of simple links BLE is aimed at low power applications running off a coin cell. BLE chip designs allow for two types of implementation, dual-mode, single-mode and enhanced past versions. In a single mode implementation, the low energy protocol stack is implemented solely. Single mode chips feature a lightweight Link Layer providing simple device discovery, ultra-power idle mode operation, and reliable point-to-multipoint data transfer. Such data transfer is made with advanced power-save and secure encrypted connections. Bluetooth technology transfers data within a user's Personal Area Network (PAN) at distances up to 100 meters, depending on device implementation. Bluetooth technology operates in the unlicensed industrial, scientific and medical (ISM) band at 2.4 to 2.485 GHz, using a spread spectrum, frequency hopping, full-duplex signal at a nominal rate of 1600 hops/sec. The wireless control device 120 includes a small computer chip containing a Bluetooth radio transmitter and software operable to connect and transfer data, via a wireless communication link, to the first transmitter/receiver 112 of the fan controller 110.

In another example embodiment, the wireless control device 120 may transmit data messages to the fan controller 110 via any other wireless communication link, such as Wi-Fi communication or wireless network. In this way, the wireless communication link can include any wireless technology standard for exchanging data from fixed and mobile devices in a PAN including, but not limited to Bluetooth, near-field communication (NFC), ZigBee, wireless universal serial bus (USB), ultrawideband (UWB), WiFi, WiMax, 3G, GSM, ANT, etc. Likewise, the first transmitter/receiver 112 of the fan controller 110 can include wireless technology to be compatible with one or more of the technology standards employed by the wireless control device 120.

The fan controller 110 may be operable to communicate data messages via wireless signals such as radio frequency signals 106 to one or more receiving units 115 via a second direct wireless communication link separate from the direct wireless communication link between the wireless control device 120 and the fan controller 110. The wireless communication links can be separated by any multiplexing method known for transmitting multiple streams of digital data over a common wireless medium including, but not limited to, frequency division multiplexing, code division multiplexing, time division multiplexing and combinations thereof. In one embodiment implementing a frequency division strategy, the wireless control device 120 transmits wireless signals to the fan controller 110 on a first frequency while the fan controller 110 transmits wireless signals to one or more fan receiving units 115 on a second frequency which is different from the first frequency.

By implementing a frequency division strategy, the radio frequency ceiling fan control system 100 enables communication between the control device 120 and the fan controller 110 without interfering with communication between the fan controller 110 and the one or more fan receiving units 115 as well as limiting interference with other wireless devices within the same area. The first and the second frequencies are selected such that the difference between the first and second frequencies is great enough to avoid adjacent-channel interference, which is electromagnetic interference that is caused by a first wireless transmitter and receiver operating at one frequency and broadcasting extraneous electromagnetic power into adjacent frequencies used by a second wireless transmitter and receiver operating at a second frequency. For example, in one embodiment, the wireless control device 120 communicates with the first radio transmitter/receiver 112 of the fan controller 110 operating in a first ISM band at a frequency between 2.4 GHz and 2.5 GHz by a Bluetooth low energy protocol and the fan controller 110 communicates with a second radio transmitter/receiver 114 operating in a second ISM band at a frequency between 433.050 MHz and 434.790 MHz.

While the wireless communication link between the fan controller 110 and the one or more receiving units 115 can include any wireless technology standard and protocol for exchanging data between electronic devices particularly for use in home automation devices including but not limited to X10, Z-Wave, One-Net, KNX-RF, etc., the fan controller 110 and the one or more receiving units 115 can communicate by a bespoke protocol implemented to encode commands for controlling a ceiling fan 130. Alternatively or in addition to the home automation protocols, the wireless communication link can include any wireless technology standard for transmitting data between fixed and mobile devices in a PAN including, but not limited to Bluetooth, near-field communication (NFC), ZigBee, wireless universal serial bus (USB), ultrawideband (UWB), WiFi, WiMax, 3G, GSM , ANT, etc.

For example, in one embodiment, the fan controller 110 and the one or more receiving units 115 communicate in the ISM band at a frequency between 433.050 MHz and 434.790 MHz via a bespoke protocol that includes the digital modulation technique of frequency-shift keying (FSK). FSK is a frequency modulation scheme in which digital information is transmitted through discrete frequency changes of a carrier wave (e.g. the center frequency 433.920 MHz of the 433.050 MHz to 434.790 MHz ISM band). That is, the second transmitter/receiver 114 of the fan controller 110 and the one or more receiving units 115 transmit data by transmitting a consecutive set of single frequencies where each single frequency is indicative of data encoded for broadcast and reception. The modulation of the data in the protocol can be any type of FSK including but not limited to continuous-phase frequency-shift keying, Gaussian frequency-shift keying, minimum-shift keying etc. Using the bespoke protocol in the 433.050 MHz to 434.790 MHz ISM band with FSK, the fan controller 110 and receiving unit 115 can be within about 150 feet of each other to communicate on the second frequency.

The processor 118 converts data messages transmitted from the wireless control device 120 and to the one or more fan receiving units 115. Similarly, the processor 118 converts data messages transmitted from the one or more fan receiving units 115 to the wireless control device 120. The data messages describe the commands and responses that to control the ceiling fans 130 from their wireless control device 120. The data messages can relate to any commands and responses including for control of such features as turning the cooling and lighting functions of the ceiling fans 130 on and off, changing the fan speeds and lighting output, creating a security function event to randomly turn on and off the lights at a certain times of day to simulate the premises being occupied, indicating the signal strength of the communication link, etc.

While the processor 118, the power supply 116, and the radio transmitter/receivers 112, 114 have been depicted and described as separate components, one or more of the elements may be implemented with electronic components including, but not limited to, a single application-specific integrated circuit (ASIC), multiple ASICs or be formed with conventional off-the-shelf components or a combination thereof. The processor 118 can include one or more software configured programs such as a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, algorithms, etc. that have the technical effect of performing particular tasks or implement particular abstract data types.

The wireless control device 120 may have an electronic visual display 122 having a touch screen which allows the user to interact with the visual display 122 through simple or multi-touch gestures by touching the screen with one or more fingers. The wireless control device 120 may download a product control application which may allow the user to operate and control the fan control system 100. For example, the product control application can be a bespoke mobile application that includes software designed to run on a smartphone or tablet and is downloaded from a digital distribution platform for mobile applications.

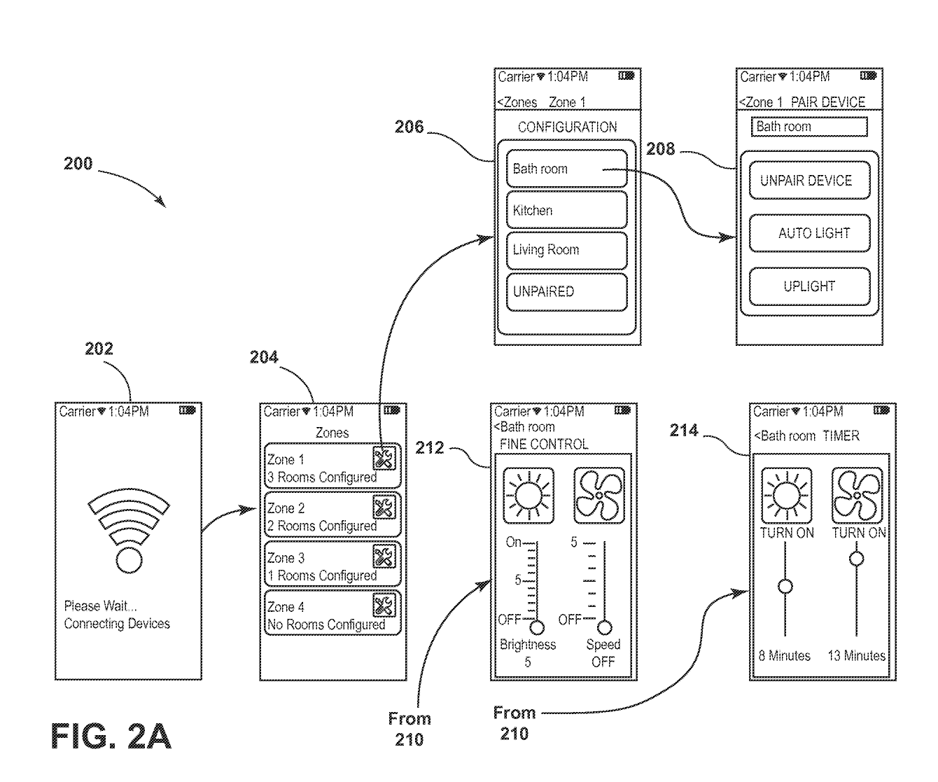

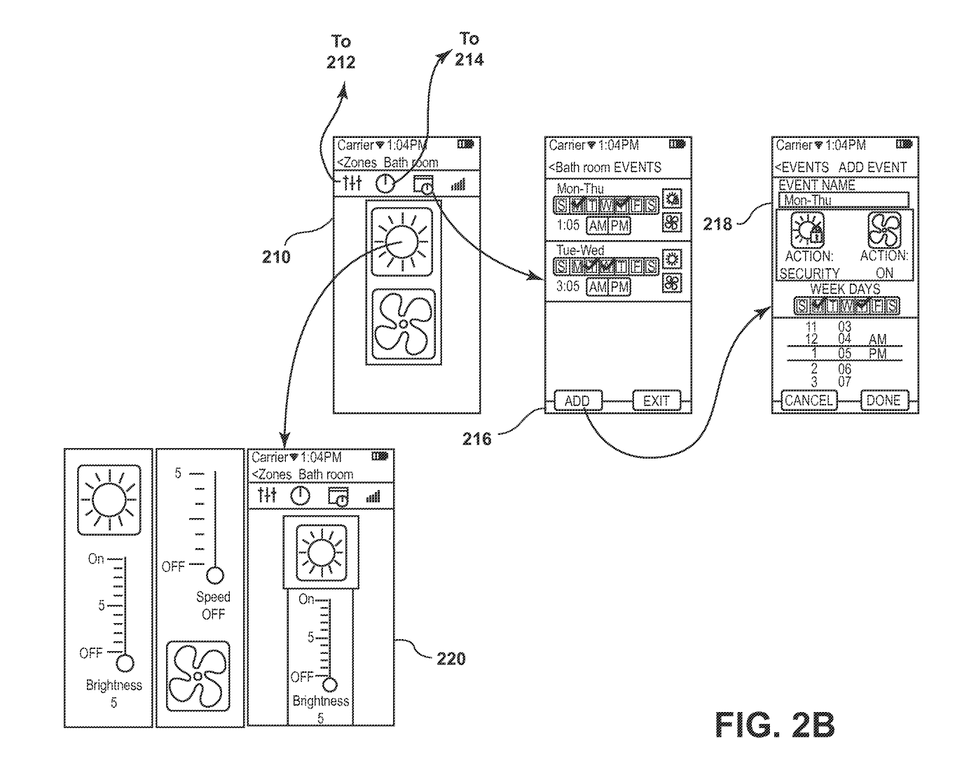

Wireless control device 120 displays a plurality of software configured buttons and controls on the electronic visual display 122 for the user to manipulate to control the fan load 104. Referring now to FIGS. 2A and 2B, when utilizing a product control application to control fan load 104, a series of screenshots 200 may be displayed on the electronic visual display 122 of the wireless control device 120. Upon launching a product control application via wireless control device 120, screenshot 202 may be displayed via electronic visual display 122 while the application is launching as well as locating and connecting wireless control device 120 with nearby one or more fan controllers 110. Wireless control device 120 may pair with any number of fan controllers 110 where pairing is the linking together of electronic devices to allow wireless communications therebetween. To pair the fan controller 110 and the wireless control device 120, the devices must be located within a range consistent with the operational parameters of the direct wireless communication link. For example, the fan controller 110 can be within 100 feet of the wireless control device 120 for a Bluetooth-based wireless communication link. Once wireless control device 120 locates and pairs with one or more fan controllers 110, product control application may display screenshot 204 which demonstrates each fan controller 110 with which the wireless control device 120 is now capable of transmitting data messages. If wireless control device 120 attempts to pair with a fan controller 110 but such fan controller 110 will not wirelessly connect to the wireless control device 120, such fan controller may not be displayed or may be “greyed out” via the product control application. A fan controller 110 may be greyed out when the wireless control device 120 is outside of the range of the direct wireless communication link with the fan controller 110, for example. When this happens, the product control application will show the fan controller 110 greyed out and thus the such fan controller is not operable by wireless control device 120. As shown in screenshot 204, the product control application may refer to or designate each fan controller 110 as a zone. It should be understood that other various designations other than “zone” may be used as desired by one of skill in the art.

Each fan controller 110 (or zone) may be configured or paired with one or more receiving units 115 located within a particular ceiling fan 130. In a preferred method of pairing the fan controller 110 with any receiving unit 115, the receiving unit 115 undergoes a power cycle procedure and then the user can select the pair option on the screenshot during the configuration process. Such pairing between fan controller 110 and at least one receiving unit 115 allows fan controller 110 to transmit radio frequency signals to the receiving unit 115 of one or more ceiling fans 130.

As seen in screenshot 206, three locations are identified and represent three receiving units 115 of three ceiling fans 130 located in three separate rooms or locations. (Screenshot 206 has identified the three rooms or locations as the bathroom, kitchen and living room). A fan controller 110 (referred to as zone 1 in screenshot 204) is capable of sending data messages or signals to each receiving unit 115 located in each ceiling fan 130 located in three separate rooms/locations displayed in screenshot 206. In one embodiment, a user of the product control application may select one particular room or location within a particular zone wherein the one particular room or location includes a ceiling fan 130 with a receiving unit 115 and subsequently manipulate several features of the lighting feature of the ceiling fan 130, including an auto light option and uplight option, or the user may choose to unpair the one location from a fan controller 110.

Once one or more zones have been set up and configured, any configured zone may be selected by the user for control and operation. In one example embodiment, in screenshot 204, three of the four zones have been set up and configured. Zone 1 has been configured with three separate receiving units 115 of ceiling fans 130 located in three separate rooms. Zone 2 has been configured with two separate receiving units 115 of ceiling fans 130 located in two separate rooms. Zone 3 has been configured with one separate receiving unit 115 of a ceiling fan 130 located in one room.

Once the user completes the configuration and set up process of at least one zone (which means the product control application has paired the wireless control device 120 with at least one fan controller 110 and such fan controller has been paired with at least one receiving unit 115 of a ceiling fan 130), the product control application may automatically display the home or default screen 210 when a user launches the application for control and manipulation of the fan ceiling control system. The default screen 210 may display the room/location (such as the bathroom, see screenshot 210), wherein such room/location has been paired with a zone (representing one fan controller) and wherein such room/location has at least one ceiling fan 130 with a receiving unit 115, wherein such ceiling fan with cooling and lighting functions has been most controlled and manipulated most recently by the user. As shown in screenshot 210 of FIG. 2, such default screen may display two banners across the top of the screen including a zone identifier banner and a settings banner. In one embodiment, the zone identifier banner may allow the user to go back to the configuration and set up process and revise such configuration when desired or needed by the user. In another embodiment, the settings banner may allow the user to manipulate and control one or more fine control features (see screenshot 212) of the cooling and lighting functions such as the brightness of the light fixture and the speed of the fan. The setting banner may allow the user to manipulate and control a timer feature (see screenshot 214) of the cooling and lighting functions.

In still a further embodiment, the settings banner may also allow the user to manipulate and control one or more scheduling features (see screenshots 216 and 218) to control the cooling and lighting functions of the ceiling fan. The scheduling features may allow the user to add events to the schedule, such events include the ability for the user to systematically turn the cooling and lighting functions on and off and to systematically change the fan speeds and lighting output. The scheduling features may also allow the user to create a security function event wherein such security function event will randomly turn on and off the lights at a certain times of day to simulate the premises being occupied. The setting banner may also indicate the signal strength of the communication link (see screenshot 210).

Referring again to default screenshot 210 of FIG. 2, the default or home screen automatically displays the fan load being monitored and controlled most often. In one embodiment, the default screen may comprise two icons representing the cooling function and lighting function. Any other icons may be adopted and used to represent the cooling and lighting functions as desired by one of skill in the art. In one embodiment, the product control application is operable so that each fan load of any fan configured to the system 100 may be controlled or monitored when either the cooling function of lighting function icons is pressed. When either of the icons is pressed, the fan's receiving unit may toggle the respective lighting or cooling output depending on the particular icon pressed. The toggle feature of the receiving unit may toggle between “off” and the fan's last known state. Such toggle feature allows the user to set a preferred setting for the fan's cooling and lighting output and then toggle between off and the preferred setting. The toggle feature allows decluttering of the main screen. In one embodiment, when one of the icons is held for a specified period of time, such as a second, the fine control overlay may display over the non-pressed icon (refer to screenshot 220). After the desired fine control is selected, the overlay will disappear.

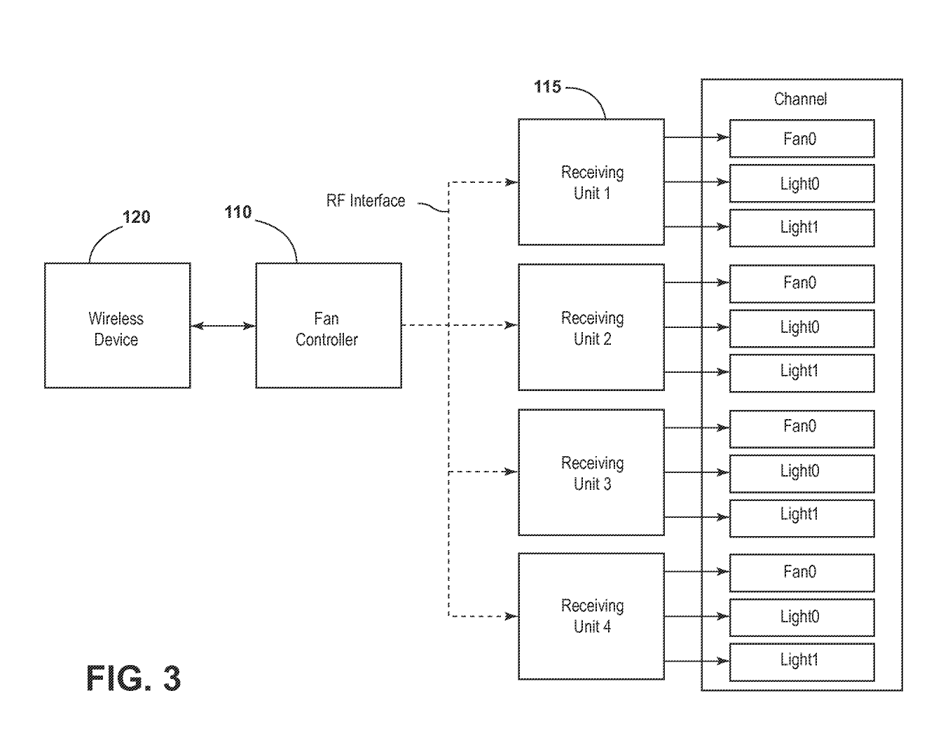

Referring now to FIG. 3, there is shown a simplified block diagram of the communication and data flow process of the ceiling fan control system. The system 100 includes the equipment or components for the transmission of wireless signals between the wireless control device 120 and the fan controller 110 on a first frequency. The wireless control device communicates data messages via wireless signals such as radio frequency signals to one or more fan controllers 110 via a direct wireless communication link, such as a Bluetooth communication technology owned by Bluetooth Sig, Inc. The wireless control device may be operable to establish a wireless communication link with one or more fan controllers. The fan controller 110 receives data messages from wireless control device 120 and then transmits data messages to the fan receiving unit of one or more ceiling fans on a second frequency which is different from the first frequency. Fan controller 110 may be operable to transmit data via radio signals to one or more ceiling fans each having receiving unit 115 which in turn manipulate the cooling and lighting features of the corresponding ceiling fan.

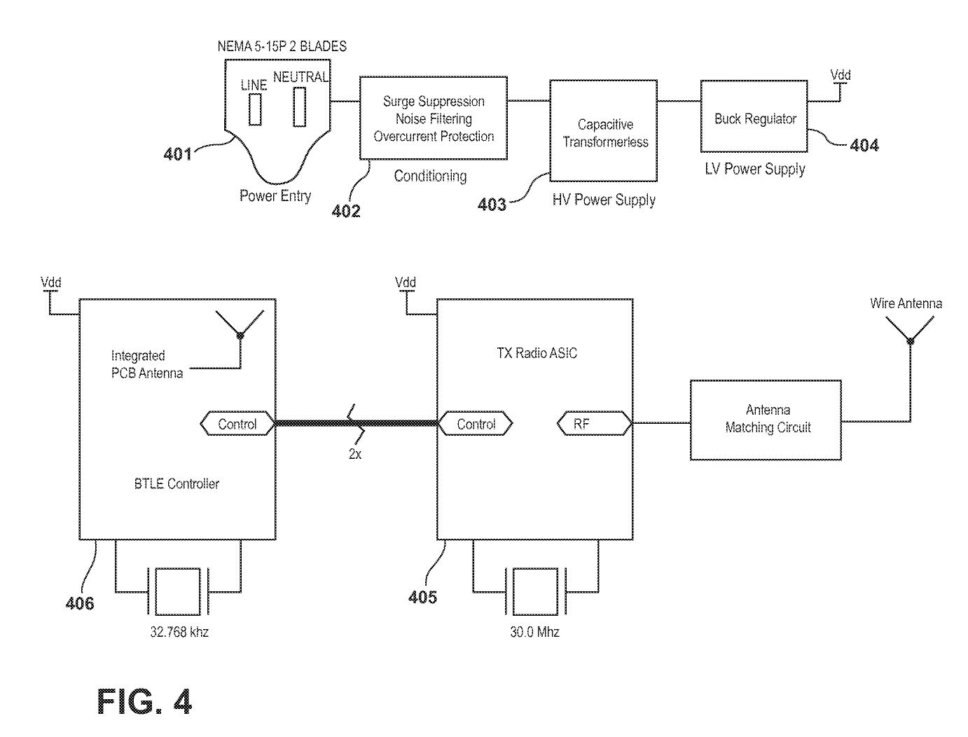

Referring now to FIG. 4, there is shown a simplified block diagram depicting the electrical components of fan controller 110 according to one example embodiment including an offline power circuit. The circuit gains access to high voltage power from a standard wall receptacle using 401. Once 401 gains access to power, 402 conditions the high voltage power source allowing the source to be stored in 403. 404 transforms the high voltage source to a usable low voltage source for 405 and 406. 405 is comprised of a processor, memory, and RF radio. 406 is comprised of a processor, memory, Bluetooth radio, and an integrated printed circuit board (PCB) antenna.

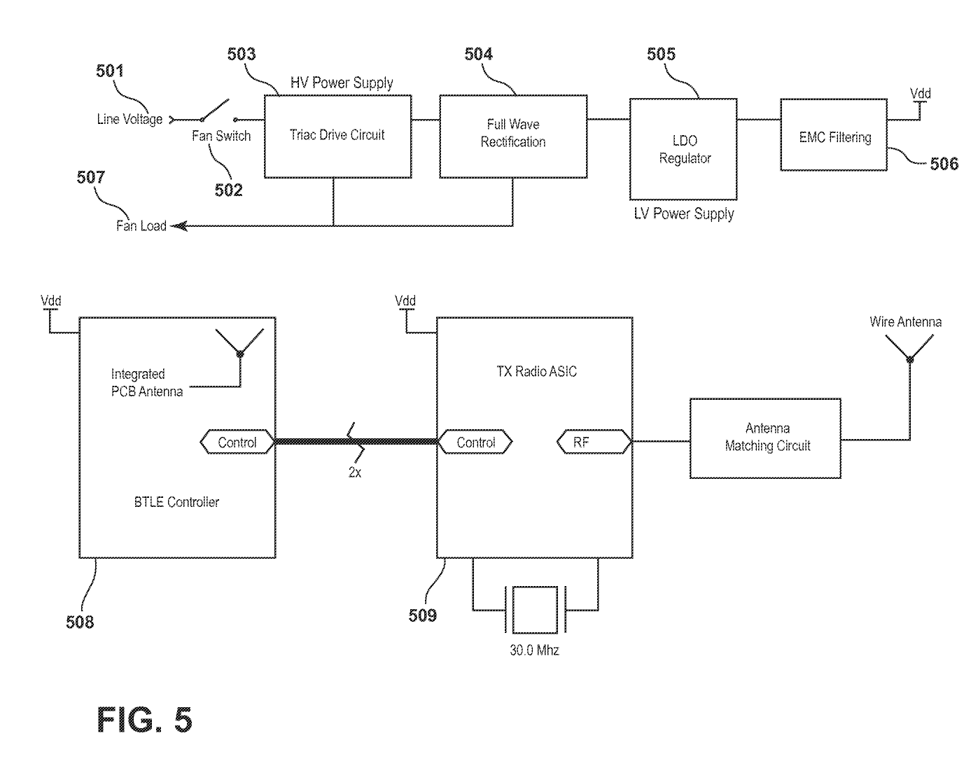

Referring now to FIG. 5, there is shown a simplified block diagram depicting the electrical components of a fan controller 110 according to another example embodiment, including an inline power stealing circuit. The circuit gains access to a power source using 501. Due to some residential building codes, a mechanical air gap switch is required 502. 503 diverts power to 507 and bleeds power to 504. Once 504 rectifies the source, 505 may transform the source to a usable voltage. 506 filters the source for use on 508 and 509. 509 is comprised of a processor, memory, and RF radio. 508 is comprised of a processor, memory, Bluetooth radio, and an integrated pcb antenna.

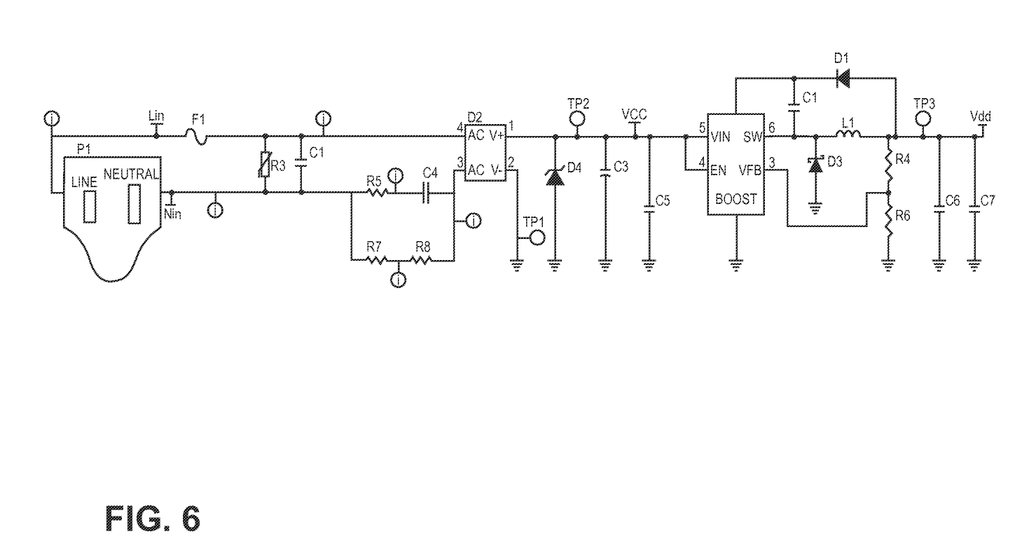

Referring now to FIG. 6, in one embodiment, the power to the control circuit of fan controller 110 may be provided by an offline power circuit, which may be placed on any line with the fan controller power switch. The capacitive transformerless power supply has the cost and size advantage of eliminating the need for a transformer in the circuit. Instead it utilizes a coupling capacitor to conduct energy into a regulation circuit. The offline power circuit design optimizes the size and cost of the high voltage components required to provide power to the RF Circuit.

As shown in FIG. 6, in one embodiment, the line voltage may be provided through connections from a NEMA 5-15P plug. Fuse F1 provides protection to the circuit due to over-currents. Varistor R3 provides circuit protection in cases of over-voltages caused by surges. Capacitor C2 provides filtering to prevent line noise from coupling to and from the power circuit. Capacitor C4 is the primary coupling device used to power the circuit. Resistor R5 is present to limit the inrush current from the line. Resistors R7 and R8 provide a filter to prevent electromagnetic interference (EMI) from travelling back onto the line. Diode bridge D2 takes the incoming energy coupled from C4 and full-wave rectifies the voltage to output VCC. The diode bridge conducts during both half-waves, thus providing the maximum amount of current for the component ratings. The diode D4 provides the regulation on the VCC rail, limiting the maximum voltage on the VCC rail. Capacitor C3 provides the bulk storage for the energy used by the buck regulator circuit. The buck regulator circuit consisting of components C5, U3, C1, D3, D1, L1, R4, R6, C6 and C7 converts the energy stored in capacitor C3 on the VCC line to load current on the VDD line.

Referring again to FIG. 6, capacitor C4 may be a line rated capacitor which means that the cost/uF is very high compared with the equivalent cost of a low voltage capacitor C3. The physical structure of C4 may also be a film variety with typical dielectrics being polyester or polypropylene. These have very unfavorable uF/volume characteristics, making the physical size of these capacitors large.

The design of the control circuit of FIG. 6 reduced the physical size of the power circuit while reducing the cost by adjusting the ratio of VCC/VDD to increasing the current available at VDD, while reducing the value of the coupling capacitor C4.

For example and for comparison purposes, instead of utilizing a buck regulator, a linear regulator is used with a half-wave rectifier circuit. Therefore in order to design a circuit that can provide 35 mA minimum to an RF Circuit, the following value is required for capacitor C4:

$$\begin{matrix}V rms = 120 VAC & 110 VAC min \\ Vz = 3.7 Volts & 3.774 V max \\ f = 60 Hz & 59.5 Hz min \\ C 4 = 1.8 μF & 1.44 μF min \\ R 5 = 220 Ohms & 242 Ohms max\end{matrix}$$

$$Iin = \frac{\sqrt{2} {V}_{rm s} - {V}_{Z}}{2 ( \frac{1}{2 π f {C}_{4}} + {R}_{5} )} = \frac{\sqrt{2} \cdot 100 - 3.774}{2 \cdot ( \frac{1}{2 π \cdot 59.5 \cdot 1.44 \cdot {10}^{- 6}} + 242 )} = 36 mA$$

For the same requirement of 40 mA, but this time utilizing the circuit in FIG. 6,

$$\begin{matrix}V rms = 120 VAC & 110 VAC min \\ Vz = 12 Volts & 12.24 V max \\ f = 60 Hz & 59.5 Hz min \\ C 4 = 0.33 μF & 0.264 μF min \\ R 5 = 100 Ohms & 110 Ohms max\end{matrix}$$

$$Iin = \frac{\sqrt{2} {V}_{rm s} - {V}_{Z}}{2 ( \frac{1}{2 π f {C}_{4}} + {R}_{5} )} = \frac{\sqrt{2} \cdot 110 - 12.24}{2 \cdot ( \frac{1}{2 π \cdot 59.5 \cdot 1.44 \cdot {10}^{- 6}} + 110 )} = 9.9 mA$$

Now the current at Vdd can be calculated using the following equation, where η is the efficiency of the buck regulator:

$$Iin ( vdd ) = \frac{{V}_{i} \cdot {I}_{i} \cdot η}{{V}_{o}} = \frac{12 \cdot 0.0099 \cdot 0.90}{3.0} = 36 mA$$

Thus, the circuit of FIG. 6 reduces the value of the coupling capacitor down by 5.5 times. This has a significant impact on the overall size of the circuit and cost. In addition, the resistor R5 power dissipation is reduced down by a factor of 10: also reducing the size and cost of the circuit.

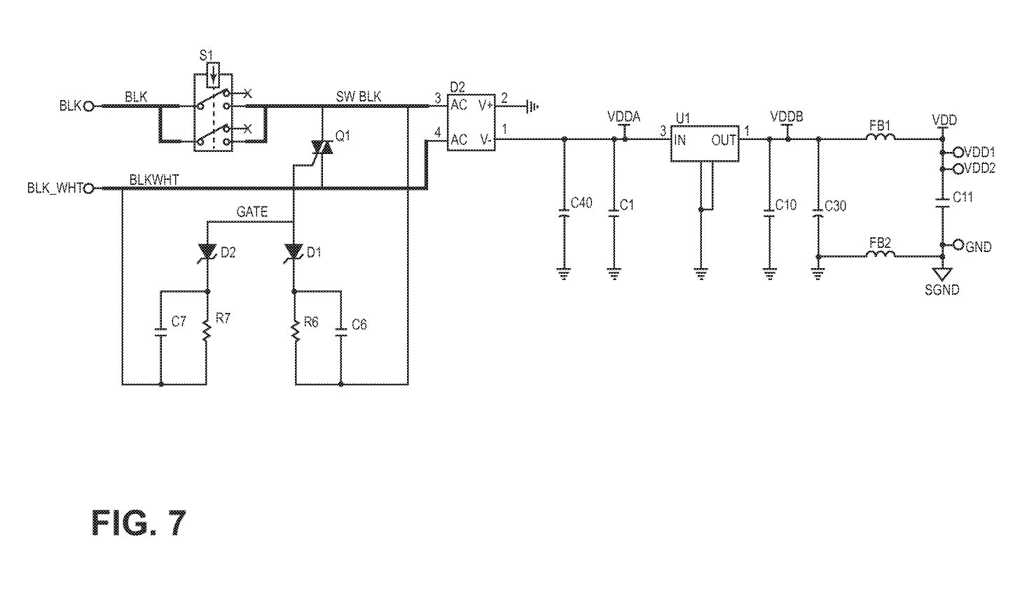

Referring now to FIG. 7, the power to the control circuit of fan controller 110 may be provided by an inline power stealing circuit, the circuit being placed inline with the fan controller power switch. Switch S1 provides a disconnect for the fan controller load and also the power stealing circuit. Triac Q1 presents an AC waveform for diode bridge rectifier D7. The Triac may be controlled with a timing circuit on the incoming line (D1, R6, and C6) or alternatively, on the outgoing line (D2, R7, and C7). The one timing circuit may be required.

As seen in FIG. 7, the triac Q1 spends most of the cycle conducting the load current from SW BLK to BLEWHT through the switch S1. At the start of a cycle, the triac is not conducting and the gate must be triggered before entering conduction mode. In quadrant I, SW_BLK is higher than the GATE signal and diode D1 prevents gate current conduction. Therefore current is conducted from SW_BLK into the diode bridge D7 pin 3 and out of pin 1, thereby charging capacitor C40. When diode D1 begins to conduct in reverse breakdown mode the current is allowed to flow through R6 in order to establish the gate trigger current for triac Q1. The gate current required may be a characteristic of the triac Q1 and can be adjusted depending on the circuit needs. Once the gate threshold current is triggered, Q1 conducts in Quadrant I mode.

For example, if the Zener voltage of D1 is 3.3V and the Igt of Q1 is 10 mA. The trigger threshold voltage on SW_BLK is: Vsw_blk=Vd1+R6*Igt=3.3V+499*0.010 V=3.3 V+4.99 V=8.29 V. The peak for 120 VAC signal is 169.7 Vpp, where

V=Vpp*sin(ø)

Ø=sin−1(VNpp)=sin−1(8.29/169.7)=2.8 Degrees

Similarly, the Triac Q1 conducts in Quadrant III mode as well:

### Vsw_blk=Vd1+R6*Igt=0.7V+499*0.010 V=0.7 V+4.99 V=5.69 V

ø=sin−1(V/Vpp)=sin−1(5.69/169.7)=1.9 Degrees

As can be seen from the conduction phase angles, the triac may be conducting most of the time except for 4.7 degrees out of the 360 degree cycle. Capacitor C40 stores the energy diverted away from the triac. The peak voltage may be less than Vsw blk during Quadrant I and III. Voltage regulator U1 provides a stable operating voltage for the radio frequency circuits by dropping the voltage down from C40 to a fixed 3.0 Volts. Capacitors C1 and C10 may be used to filter high frequency noise out from the line, preventing it from reaching the RF Circuits. Capacitor C30 provides bulk energy for any bursts during transmission of the RF circuit. Ferrite Beads FB1, FB2, and C11 may provide additional filtering on the power provided to the RF Circuit. The output power VDD is a clean, stable voltage rail suitable for powering a RF Circuit.

It is to be understood that the foregoing sizes of the electrical components of the illustrative circuits, such as capacitors, resistors, diodes, and the like, are merely examples and that any other suitable size may be used as desired by one of skill in the art. Additionally, it should be understood that the system includes the equipment or components for the transmission of wireless signals between the control device 120 and the fan controller 110 on a first frequency and the transmission of wireless signals between the fan controller 110 and the fan receiving unit on a second frequency which is different from the first frequency. This enables the system to allow communication between the control device and the ceiling fan without interfering with communication between the control device and other wireless devices within the same area.

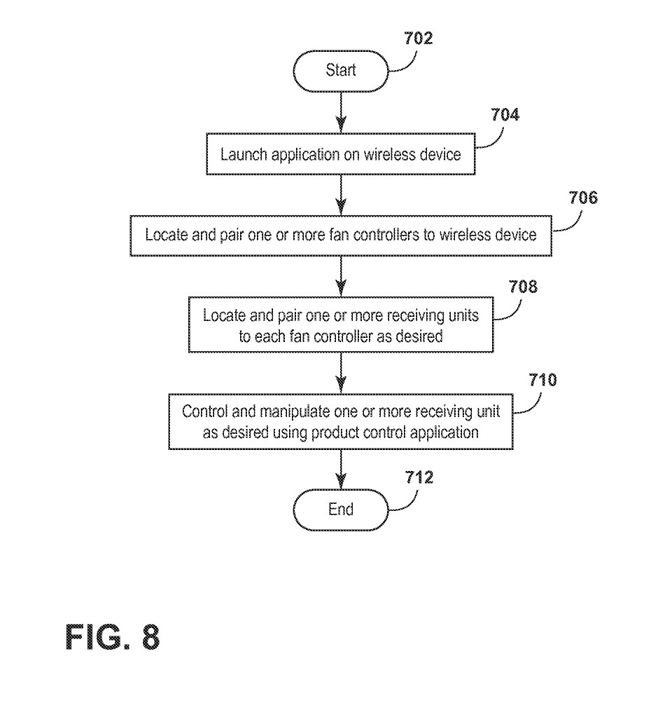

Referring now to FIG. 8, a method of controlling and manipulating the functional features, including the cooling and lighting functions, of one or more ceiling fans, wherein such fan control and manipulation is via a wireless device, is also disclosed. Such method comprises (1) launching the product control application via a wireless device 704; (2) locating and pairing at least one fan controller to the wireless device 706; (3) locating and pairing one or more receiving units to said at least one fan controller as desired 708; and (4) controlling and manipulating at least one receiving units as desired using the product control application of the system.

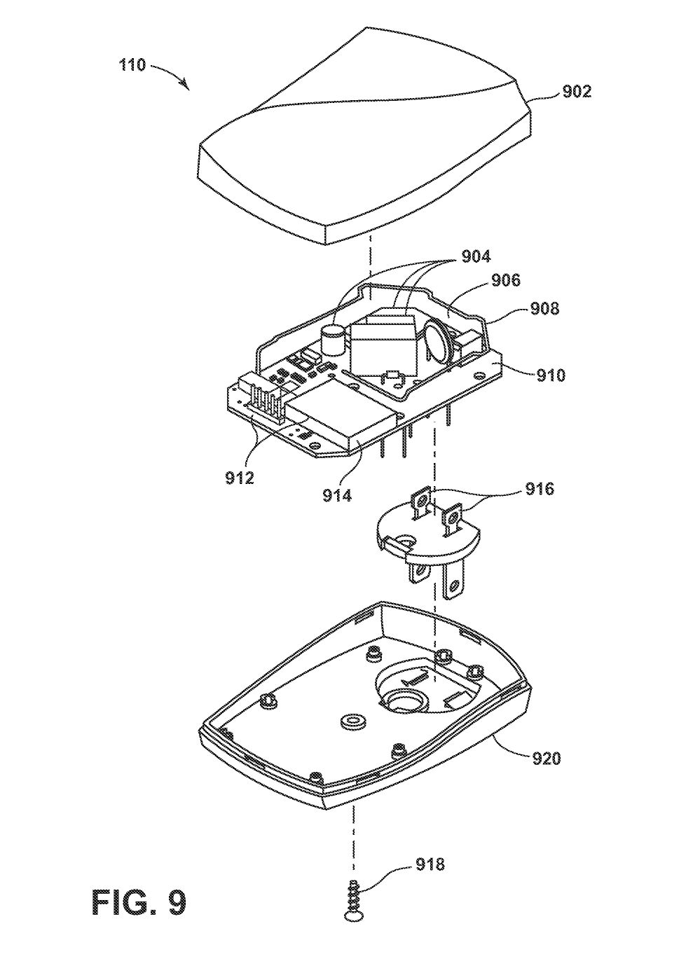

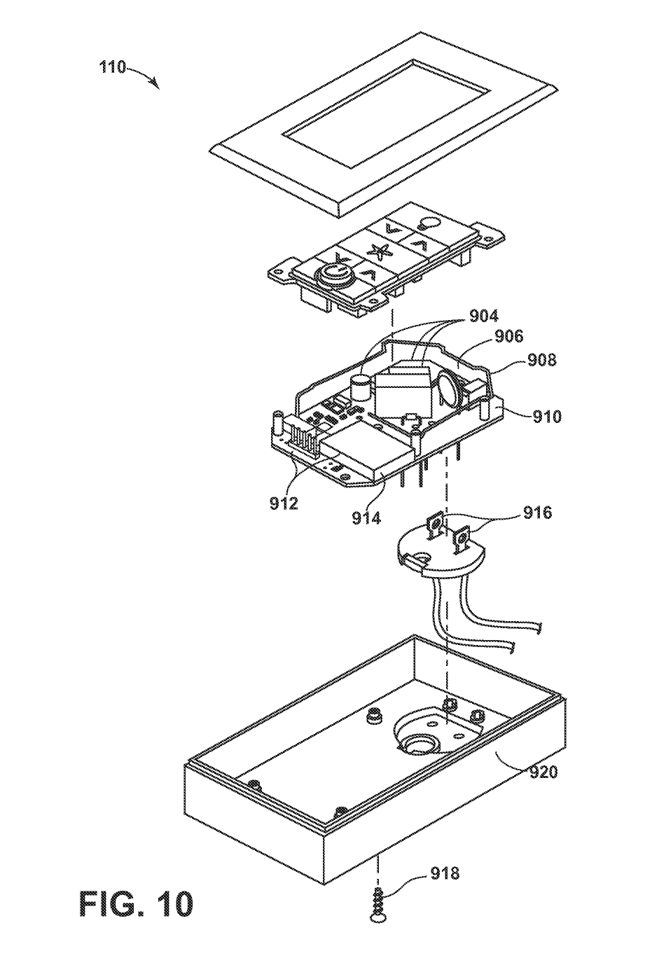

The fan controller 110 may be a plug in device as shown in FIG. 9 or mounted to the wall as shown in FIG. 10. The fan controller 110 is operable to receive radio signals from wireless control device 120 on a first frequency and is operable to transmit radio signals to a fan's receiving unit via a second frequency that is different from the first frequency. In one embodiment, the fan controller 110 of FIG. 9 comprises a housing having a cover portion 902 and base portion 920. The power stealing circuit located within fan controller 110 may comprise printed circuit board 910 which mechanically supports and electrically connects a primary communication module and processor 912, a secondary communication module 914, an antenna 908, line caps 904 for filtering and surge protector 906. Fastener 918 may be used to assemble the components of fan controller 110. In one embodiment, fan controller 110 may be plugged into a receptacle in the wall by way of connector 916. In one embodiment, the fan controller 110 of FIG. 10 mounts to the wall and additionally includes manual controls for one or more ceiling fans. It is contemplated that the manual controls supercede any commands issued by a user via the wireless control device, though in other implementations, the priority of the commands from the manual controls with respect to the commands issued via the wireless control device can be dynamic.

The foregoing disclosure has been set forth merely to illustrate the invention and is not intended to be limiting. Since modification of the disclosed embodiments incorporating the spirit and substance of the invention may occur to persons skilled in the art, the invention should be construed to include everything within the scope of the disclosed invention and equivalents thereof.

What is claimed is:

1. A ceiling fan controller for controlling the operation of one or more ceiling fans using a wireless device, the ceiling fan controller comprising:
a first radio transmitter/receiver operating at a first frequency suitable for communicating with the wireless device;
a second radio transmitter/receiver operating at a second frequency, different from the first frequency, suitable for communicating with the one or more ceiling fans;
a processor operably coupled to the first and second radio transmitters to control the sending and receiving of data messages to and from the wireless device and the ceiling fan to control the operation of the ceiling fan via the wireless device; and
a power supply configured to receive power from a power source independent of the wireless device and the fan controller and supplying the received power in a form usable by the first and second radio transmitters.

2. The ceiling fan controller of claim 1 wherein the first frequency is higher than the second frequency.

3. The ceiling fan controller of claim 2 wherein the first frequency lies within a first unlicensed industrial, scientific and medical band (ISM band).

4. The ceiling fan controller of claim 3 wherein the first ISM band is between 2.4 to 2.5 GHz.

5. The ceiling fan controller of claim 4 wherein the second frequency lies within a second unlicensed industrial, scientific and medical band (ISM band).

6. The ceiling fan controller of claim 5 wherein the second ISM band is between 433.050 MHz and 434.790 MHz.

7. The ceiling fan controller of claim 1 wherein the difference between the first and second frequencies is great enough to avoid adjacent-channel interference.

8. The ceiling fan controller of claim 1 wherein the processor sends and receives data messages over the first radio transmitter using a Bluetooth low energy protocol.

9. The ceiling fan controller of claim 8 wherein the processor sends and receives data messages over the second radio transmitter using a protocol that includes a frequency-shift keying modulation.

10. The ceiling fan controller of claim 9 wherein the processor converts data messages between the Bluetooth protocol and the protocol that includes the frequency-shift keying modulation.

11. The ceiling fan controller of claim 1 wherein the processor is programmed to control multiple ceiling fans.

12. A ceiling fan system for use in controlling ceiling fans by a wireless device communicating at a first radio frequency, the ceiling fan system comprising:
multiple ceiling fans having a radio frequency receiving unit operating at a second frequency, different than the first frequency; and
a ceiling fan controller comprising:
a first radio transmitter/receiver operating at the first frequency to communicate with the wireless device;
a second radio transmitter/receiver operating at a second frequency to communicate with the multiple ceiling fans;
a processor operably coupled to the first and second radio transmitters to control the sending and receiving of data messages to and from the wireless device and the ceiling fan to control the operation of the ceiling fans via the wireless device.

13. The ceiling fan system of claim 12 wherein the controller is programmed to discover the multiple ceiling fans.

14. The ceiling fan system of claim 12 wherein the processor converts data messages received by the first radio transmitter/receiver and transmits the converted data messages to the receiving unit.

15. The ceiling fan controller of claim 12 wherein the first frequency lies within a first unlicensed industrial, scientific and medical band (ISM band).

16. The ceiling fan controller of claim 15 wherein the first ISM band is between 2.4 to 2.5 GHz.

17. The ceiling fan controller of claim 16 wherein the second frequency lies within a second unlicensed industrial, scientific and medical band (ISM band).

18. The ceiling fan controller of claim 17 wherein the second ISM band is between 433.050 MHz and 434.790 MHz.

19. The ceiling fan controller of claim 12 wherein the processor sends and receives data messages over the second radio transmitter/receiver using a protocol that includes a frequency-shift keying modulation.

20. The ceiling fan controller of claim 12 wherein the processor converts the data messages between a Bluetooth protocol and a protocol that includes a frequency-shift keying modulation.
